(19) United States
(12) Patent Application Publication
(10) Pub. No.: US 2025/0344637 A1
(43) Pub. Date: Nov. 13, 2025

(54) Arrangement for Controlling the Speed of a Harvesting Machine

(71) Applicant: DEERE & COMPANY, MOLINE, IL (US)

(72) Inventors: Tobias Peschke, Neustadt a.d. Weinstrasse (DE); Philipp Muench, KAISERSLAUTERN (DE); Veda Nidhin, KAISERSLAUTERN (DE)

(21) Appl. No.: 19/200,489

(22) Filed: May 6, 2025

(30) Foreign Application Priority Data
May 7, 2024 (DE) 102024112825.9

(51) Int. Cl. A01D 41/127; G06Q 10/0631; G06Q 50/02

(52) U.S. Cl. CPC A01D 41/127; G06Q 10/0631; G06Q 50/02

(57) ABSTRACT

A system for the automatic control of a forward drive speed of a harvesting machine comprising: a controller configured with a function device and a solution device, wherein the function device is configured, in chronologically successive steps, taking into account a location-dependent forecast for an expected crop stand density and a measured crop stand density in the harvesting machine to create a cost function and an associated optimization problem with the effect of optimizing a state of the harvesting machine and the solution device is configured to provide respective chronologically successive first sequences of control variables relating to a pre-definition of the forward drive speed, which solve the respective optimization problem and minimize the associated cost function.

### RELATED APPLICATIONS

This document claims priority based on German Patent Application No. 102024112825.9, filed on May 7, 2024, which is hereby incorporated by reference into this application.

### FIELD OF THE DISCLOSURE

The present disclosure relates to a method, system and apparatus for controlling the forward drive speed of a harvesting machine.

### BACKGROUND

Agricultural harvesting machines are used to harvest plants from a field. As a rule, processing processes take place in the harvesting machine to treat the crop for the purpose of subsequent further processing. Thus, the crop is cut in a forage harvester and threshed, separated and cleaned in a combine harvester. The drive of the harvesting machine is provided by a drive motor, which is usually a (diesel) internal combustion engine. The drive motor drives the ground engagement means (wheels or caterpillar tracks) of the harvesting machine via a first drive train, and the crop processing and/or conveying means of the harvesting machine via a second drive train.

### SUMMARY OF THE DISCLOSURE

A system for the automatic control of a forward drive speed of a harvesting machine comprising: a controller configured with a function device and a solution device, wherein the function device is configured, in chronologically successive steps, taking into account a location-dependent forecast for an expected crop stand density and a measured crop stand density in the harvesting machine to create a cost function and an associated optimization problem with the effect of optimizing a state of the harvesting machine and the solution device is configured to provide respective chronologically successive first sequences of control variables relating to a pre-definition of the forward drive speed, which solve the respective optimization problem and minimize the associated cost function; and a valve control device configured to influence the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

A harvesting machine comprising: a controller configured with a function device and a solution device, wherein the function device is configured, in chronologically successive steps, taking into account a location-dependent forecast for an expected crop stand density and a measured crop stand density in the harvesting machine to create a cost function and an associated optimization problem with the effect of optimizing a state of the harvesting machine and the solution device is configured to provide respective chronologically successive first sequences of control variables relating to a pre-definition of The forward drive speed, which solve the respective optimization problem and minimize the associated cost function; and a valve control device configured to influence the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

A method for the automatic control of a forward drive speed of a harvesting machine comprising: providing a controller configured with a function device and a solution device; generating, with the function device, in chronologically successive steps, a location-dependent forecast for an expected crop stand density and a measured crop stand density in the harvesting machine to create a cost function and an associated optimization problem with the effect of optimizing a state of the harvesting machine; generating, with the solution device, respective chronologically successive first sequences of control variables relating to a pre-definition of the forward drive speed, which solve the respective optimization problem and minimize the associated cost function; and influencing, with a valve control device, the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

### BRIEF DESCRIPTION OF THE DRAWINGS

The above-mentioned aspects of the present disclosure and the manner of obtaining them will become more apparent and the disclosure itself will be better understood by reference to the following description of the examples of the disclosure, taken in conjunction with the accompanying drawing, wherein:

FIG. 1 is a schematic side view of an agricultural harvesting machine in the form of a combine harvester,

FIG. 2 is a schematic of an arrangement for controlling the forward drive speed of the harvesting machine from FIG. 1,

FIG. 3 is a detailed diagram of the control device of the arrangement from FIG. 2, and

FIG. 4 is a flow chart of the mode of operation of the control device.

### DETAILED DESCRIPTION

Various approaches to automatically regulating the forward drive speed of a harvesting machine have been disclosed, in order to ensure that the available power of the drive motor is utilized as optimally as possible, i.e. the harvesting machine does not travel too slowly and operates uneconomically but also does not travel too quickly and overload the drive motor, or block the crop processing elements in the event of excessively high throughputs. A relatively simple approach thereto is to measure the current crop throughput in the harvesting machine and to compare it with a desired crop throughput to produce a control variable for a speed presetting device (see German Patent No. DE 1 199 039 B1). In another approach, throughput to be expected is calculated predictively on the basis of preceding harvesting operations, in order to adapt the forward drive speed in good time before a relatively large change in the crop throughput is to be expected (German Patent No. DE 44 31 824 C1), or sensors are used on the harvesting machine, which sense crop in front (European Patent No. EP 2 764 764A1) or beside the harvesting machine (German Patent No. DE 10 2014 208 068 A1) and, on this basis, can plan and set the speed of the harvesting machine predictively. A comparison can be made here between the expected throughputs and throughputs acquired in the harvesting machine and the predictive sensor can be calibrated on this basis (German Patent No. DE 101 30 665 A1).

In another approach, predictive planning and setting of the speed of a harvesting machine (European Patent No. EP 3 348 130 A1) provides for an optimization problem to be created with the aid of a dynamic (mathematical) model for the harvesting machine and its operating state and with the aid of a cost function. This cost function assigns higher costs to undesired machine states than desired machine states and takes secondary conditions into account. One solution device provides planning of the control variable (usually a variable related to a change of speed of travel in the combine harvester) which contains a sequence of proposed control commands. Accordingly, a formulation of the load regulation of the drive motor of the harvesting machine is carried out as an optimization problem while secondary conditions are considered. It is thus possible to carry out a comprehensive optimization of various control variables (such as a throughput-dependent variable, which may be the drive torque of a crop processing device (threshing rotor), drive motor power, grain losses) with weighting of the individual control variables and a variable (sum of the speed changes) determining the driving comfort. The optimization software calculates an optimized speed of travel over a specific planning horizon (prediction time period) by using the model, wherein in particular the throughput-dependent variable, the drive motor power and/or the grain losses are input while taking the aforementioned weightings into account. In the definition of the cost function and of the optimization problem, in addition to measured and/or observed machine states which, for example, relate to the current flow rate of the crop and/or utilization of the drive motor, the predictively determined expected throughput, or the latest stand density determined together with the respective forward drive speed of the harvesting machine, is taken into account.

The planning of the sequence for the control commands relating to presetting the speed is accordingly also based on an expected stand density (which, for example, can be measured in the form of the plant mass or the plant volume per unit area), which can be based on a stored map in which the stand densities to be expected or other variables which indicate the stand density are stored in a geo-referenced manner, or which is determined by a forward-looking sensor (camera, laser scanner, etc.). In some cases, these predictions are subject to certain errors, be it when creating the map, often when converting into throughputs on the basis of specific models (e.g. for plant growth) or given unfavorable viewing conditions for forward-looking sensors. Since the intention is to operate the harvesting machine as close as possible to the load limit, there is the danger that in the event of inaccurate predictions, overloading of the drive motor and of the crop conveying and processing elements of the harvesting machine will occur, specifically when more crop runs in than was expected. This overloading leads to a reduction in the motor rotational speed which, in turn, causes a reduction in the processing quality in the harvesting machine, since the crop processing elements have been designed for a given, constant drive rotational speed. In a combine harvester, when the motor rotational speed is reduced because of overloading, higher losses accordingly occur in the cleaning and a higher proportion of contaminants in the grain tank than at nominal rotational speed. In the extreme case, the harvesting machine can even become blocked when overloaded with crop.

In European Patent No. EP 3 348 130 A1 a disturbance observer is described, which detects the actual throughput within the harvesting machine and compares it with the expected throughput, in order if necessary to adapt the control commands for the valves relating to speed control. This is a purely reactive system, which often reacts too late to avoid the aforesaid problem of possible errors in the prediction of the throughputs. Although, in principle, the harvesting machine could be operated with a throughput which lies below the maximum throughput, see German Patent No. DE 10 2014 216 593 A1, with an operator input relating to presetting the throughput to be controlled, this is at the cost of productivity and economy.

Control of the forward drive speed of the harvesting machine operates in such a way that an optimization problem is created with the aid of a model for the harvesting machine and its operating state and with the aid of a cost function. This cost function assigns higher costs to undesired machine states than desired machine states and takes secondary conditions into account. One solution device provides planning of the control variable (usually a variable related with a change in the speed of travel in the harvesting machine), which contains a sequence of proposed control commands. Accordingly, a formulation of the load regulation of the drive motor of the harvesting machine is carried out as an optimization problem while secondary conditions are considered. It is thus possible to carry out a comprehensive optimization of various control variables (such as a throughput-dependent variable, which may be the drive torque of a crop processing device (threshing rotor), or the drive motor power) with weighting of the individual control variables and a variable (sum of the speed changes) determining the driving comfort. The optimization software calculates an optimized speed of travel over a specific planning horizon (prediction time period) by using the model, wherein in particular the stand density-dependent or throughput-dependent variable and/or the drive motor power are input whilst taking the aforementioned weightings into account.

In the definition of the cost function and of the optimization problem, in addition to measured and/or observed machine states which, for example, relate to the current flow rate of the crop and/or utilization of the drive motor, the expected stand density determined predictively (namely by a device for determining the expected stand density of the crop picked up by the harvesting machine as a function of the position of the harvesting machine) is taken into account. To this end, by using the sequence of planned speeds of the harvesting machine and measured and/or observed machine states, a sequence of expected positions of the harvesting machine can be calculated, to feed the associated expected stand densities as a function of time to the optimization problem.

It is now proposed, in the intrinsically known manner outlined, to create a first sequence of control commands in which it is assumed that the signals provided relating to the expected stand densities are correct, at least within the range of a specific tolerance. In addition, while considering a parameter which represents an uncertainty of the stand density to be expected, at least one chronologically first value of a second sequence of control commands is created, which takes account of this uncertainty. The second sequence is accordingly calculated more cautiously and therefore includes lower speed values (optionally also accelerations which, for example, can be contained in the cost function of the second sequence), which are calculated in such a way that overloading of the harvesting machine does not occur, even if the actual value of the stand density should be greater by the uncertainty than the predicted stand density. The chronologically first value of the two sequences is identical and is also fed to a speed presetting device of the harvesting machine.

In the next step, two new sequences of control commands are calculated based on new state measurements of the harvesting machine. These state measurements include information relating to the actual stand density which, for example, can be based on a measured loading of the internal combustion engine and/or on a direct or indirect measurement of the throughput in the harvesting machine or the stand density derived therefrom. On this basis, the above-described creation of the cost function and of the optimization problem and its solution with the creation of the first sequence and at least the chronologically first value of the second sequence, which corresponds to that of the first sequence, is carried out again. A possible actual error in the prediction of the stand density is taken into account by the state measurements, the cost function, the optimization problem and its solution, so a self-teaching system is obtained which—in the form of the corresponding first control commands of the first and second sequence—takes into account the possible errors in the prediction of the stand density and avoids undesired machine states by the possible errors being taken into account in the new sequence.

This procedure is continued continuously, so that the control algorithm calculates two sequences of control commands again and again, of which the first is based on correct, predicted stand densities and the second on erroneous predicted stand densities, be these too small or too large. The first control command of the two sequences is equal and is used for speed regulation.

The parameter representing the uncertainty of the stand density to be expected can be fixedly predefined, entered by an operator via an operator interface or determined by using a comparison between the predicted and measured stand densities. In principle, the uncertainty can also vary over the prediction horizon of the algorithm. Accordingly, the map with the stand density can also contain associated uncertainties, which may also be analogously true of the signal from local, forward-looking sensors. The operator can also enter a weighting as to whether they prefer safer operation, i.e. speed control based on the second, more cautious sequence, or fast operation, based on the first, less cautious sequence. Intermediate values can also be entered, for example via a virtual slide controller.

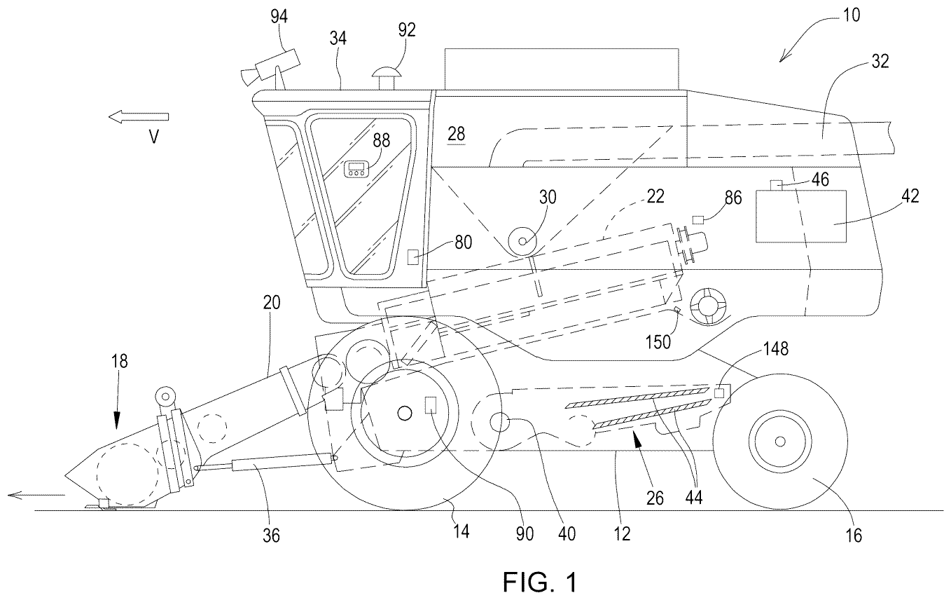

FIG. 1 shows a self-propelled harvesting machine 10 in the form of a combine harvester having a chassis 12, which is supported on the ground by driven front wheels 14 and steerable rear wheels 16 and is moved by said wheels. The harvesting machine can be designed as a combine harvester or forage harvester or baling press in a self-propelled or towed embodiment.

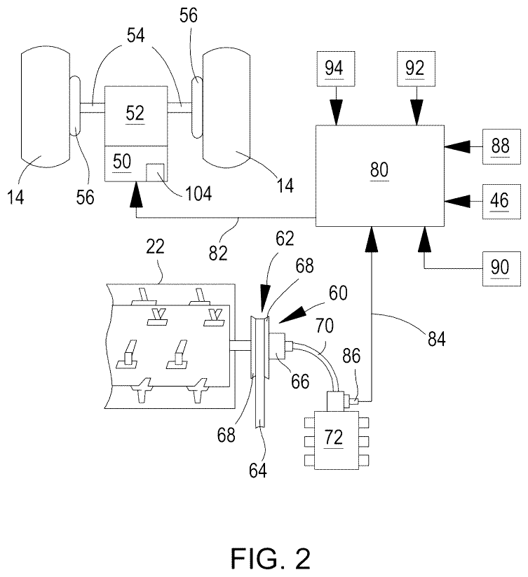

The wheels 14, 16 are set into rotation by a drive system (shown in FIG. 2) to move the harvesting machine 10, for example, over a field to be harvested. In the following text, direction indications, such as front and rear, relate to the direction of travel V, running to the left in FIG. 1, of the harvesting machine 10 in harvesting operation.

A harvesting header 18 in the form of a cutting unit is removably connected to the front region of the harvesting machine 10 to harvest crops in the form of cereals or other threshable stalk crops from the field during harvesting operation and to feed them upward and rearward through a feeder house assembly 20 to an axial threshing unit 22. The mixture passing through threshing concaves and gratings in the axial threshing unit 22 and containing grains and contaminants passes into a cleaning device 26. Cereal cleaned by the cleaning device 26 is supplied by a grain screw to a grain elevator, which conveys said cereal into a grain tank 28. The cleaned cereal from the grain tank 28 can be discharged by a discharge system having a transverse screw 30 and having a discharge conveyor 32. The aforementioned systems are driven by an internal combustion engine 42, to which an engine controller 46 is assigned, and are monitored and controlled by an operator from a driver's cab 34, for which purpose an operator interface 88 is provided. The axial threshing unit 22 is merely an example and could be replaced by a tangential threshing unit with straw walkers or separating rotors arranged downstream.

### Speed Control Hardware

Reference is now made to FIG. 2. The front wheels 14 of the harvesting machine 10 are driven by a hydrostatic transmission 50. The hydrostatic transmission 50 is driven by the internal combustion engine 42 in a conventional manner. The hydrostatic transmission 50 in turn drives a multi-speed gearbox 52. Two driving shafts 54 extend outward from the multi-speed gearbox 52 and drive final drives 56 of the front wheels 14. The hydrostatic transmission 50 comprises a pump unit and a motor unit, wherein the pump unit could also be arranged at a distance from the motor unit. The pump unit and/or the motor unit are equipped with adjustable swash plates. The adjustable swash plates control the output speed of the transmission 50 and the direction of rotation thereof. Electromagnetically controlled control valves 104 control the positions of the swash plates. The steerable rear wheels 16 can also be driven by wheel motors which are fastened directly to the wheels 16, which is also analogously true of the front wheels 14. The speed of the wheel motors can likewise be controlled by the arrangement described below for the automatic control of the forward drive speed.

An adjustable drive 60 with variable torque drives the rotor of the axial threshing unit 22. The same internal combustion engine 42, which also drives the hydrostatic transmission 50, also drives the adjustable drive 60. The adjustable drive 60 is a belt drive, which comprises a driving belt pulley, not shown, with a variable diameter, and a driven belt pulley 62 with a variable diameter. A belt 64 extends between the driving belt pulley and the driven belt pulley 62, in order to transmit rotational power. Hydraulic cylinders control the diameters of the belt pulleys. The hydraulic cylinder 66 is coupled to the driven belt pulley 62 and moves the end plates 68 of the belt pulley 62 inward or outward to control the effective diameter of the belt pulley 62 with respect to the belt 64. By changing the effective diameter of the belt pulleys, the effective speed of the driven belt pulley 62 is changed. Hydraulic fluid under pressure is fed to the hydraulic cylinder 66 through a hydraulic line 70 by a valve assembly 72. The rotor of the axial threshing unit 22 is driven at a constant, selected rotor speed by the belt pulleys of variable diameter. The torque transmitted by the belt 64 and the belt pulleys varies with the product throughput.

An electronic controller 80 (also interchangeably referred to as control device 80) controls the forward drive speed and thus the harvesting speed of the harvesting machine 10. This means that the electronic control device 80 sets the forward speed (harvesting speed) of the combine harvester 10 by adjusting the position of the swash plates of the hydrostatic transmission 50, by the operation of the electromagnetically operated control valves 104 being controlled via a line 82. The control device 80 receives a current hydraulic pressure signal from a hydraulic pressure sensor 86 through the line 84. The hydraulic pressure sensor 86 senses the hydraulic pressure of the hydraulic cylinder 66, which adjusts the drive 60 with a variable torque. The hydraulic pressure with which the hydraulic cylinder 66 adjusts the drive 60 has a clear relationship with the throughput. Accordingly, a signal which contains information relating to the actual crop throughput of the harvesting machine 10 is applied to the control device 80 via the line 84. In addition, the control device 80 receives signals relating to the current forward drive speed V of the harvesting machine 10 from a speed sensor 90. The speed sensor 90, for example as a radar sensor, can detect the speed of the harvesting machine 10 with respect to the ground or the rotational speed of one of the front wheels 14. Also fed to the control device 80 is a signal relating to the power respectively output by the internal combustion engine 42, which signal can be provided by the motor controller 46 and can be based on the fuel consumption of the motor controller and/or a measurement of the torque on the crankshaft of the internal combustion engine 42. The operator interface 88 is also connected to the control device 80.

### Speed Control Software

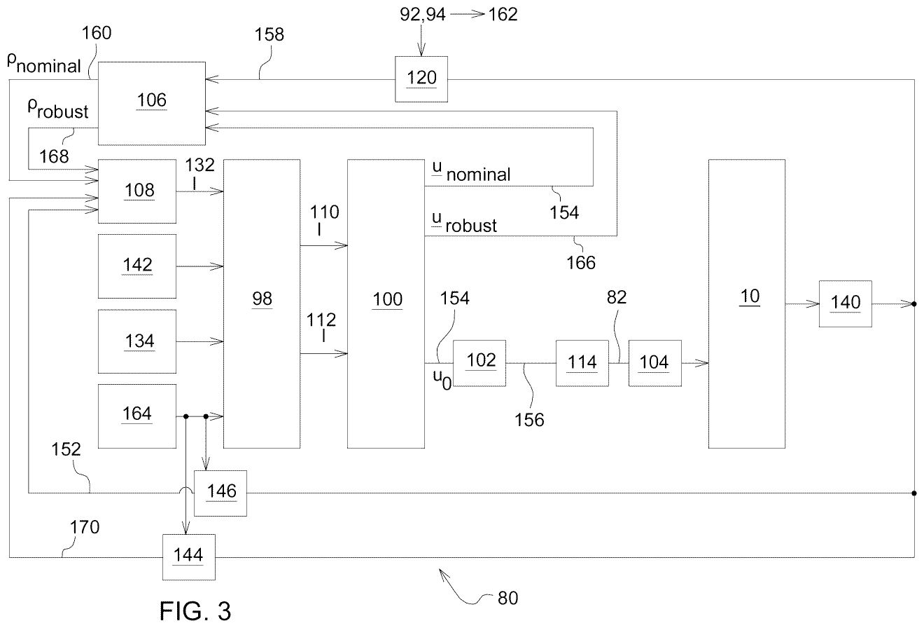

FIG. 3 shows the structure of the control device 80 in more detail. It comprises, inter alia, a function device 98 for creating an optimization problem and a cost function, a solution device 100, a speed presetting calculation device 102, a conversion device 106 and a valve control device 114 for activating the control valves 104.

The device 98 for creating the optimization problem and the cost function is used to implement model-based, predictive control of the forward drive speed of the harvesting machine 10. The device 98 (or the control device 80) contains a processor or the like, which is programmed to create an optimization problem and an associated cost function by using variables describing the respective operating state of the harvesting machine 10 and at least one secondary condition.

A mathematical prediction model 132, which is provided by a forecasting model 108, is fed to the device 98 as an input value. The forecasting model 108 creates the prediction model 132, amongst other things by considering a forecast about the stand densities as a function of time to be expected on the further path of the harvesting machine 10 over the field, as described further below. Also fed to the device 98 are control parameters 134, for example relating to set values of crop processing devices of the harvesting machine 10 and/or crop properties.

Also fed to the device 98 are data 142 relating to secondary conditions which, for example, may represent limiting values of the harvesting machine 10, such as maximum speed, maximum acceleration and retardation, maximum throughput or maximum pressure at the hydraulic pressure sensor 86. These data 142 can be fixedly predefined and stored in a memory or (preferably only in the presence of administrator rights) can partly or wholly be able to be entered by the operator input device 88.

During operation, the device 98 calculates the variables for an optimization problem and an associated cost function 110. In this regard, reference should be made generally to European Patent No. EP 3 348 130 A1 and the references cited there, the contents of which are incorporated in the present documents by reference. The optimization problem represents a model of the harvesting machine 10 and depends on its respective operating state. The cost function 110 assigns lower costs to desired operating states than to undesired operating states. The variables of the optimization problem, namely the cost function 110 and restrictions 112 (the last-named of which are to be understood in the mathematical sense and represent a set of equations and inequalities which include the mathematical prediction model 132 including the data 142 for the secondary conditions), are fed to the solution device 100, which generates a sequence 154 of control variables. The sequence 154 solves the optimization problem and minimizes the associated cost function. The sequence of control variables 154 represents a successive sequence of target variables, which include information relating to the speed of the harvesting machine. The sequence of control variables 154 can be relative values, for example values corresponding to a position of a manually operable speed presetting means (pedal or hand lever).

The sequence of control variables 154 is fed by the solution device 100 to the speed presetting calculation device 102, which converts the sequence of control variables 154 to a sequence 156 of absolute speeds. In each case only the chronologically first value u₀ of the sequence 154 is fed to the speed presetting calculation device 102, which outputs control commands to the control valves 104 via the valve control device 114 and the line 82.

The harvesting machine 10 accordingly moves over a field at a variable speed. The result is a specific operating situation, which can be detected by various sensors 140. The sensors 140 of the harvesting machine 10 comprise, for example, a grain loss sensor 148 at the end of the upper screen of the cleaning device 26 and/or a grain loss sensor 150 at the outlet of the axial threshing unit 22 and/or a tailings sensor (not shown) for detecting the quantity and/or the proportion of grain in the tailer, which conveys unthreshed material from the lower screen of the cleaning device 26 back to the axial threshing unit 22 or a separate re-thresher, and/or the speed sensor 90 and/or a loading of the internal combustion engine 42 provided by the engine controller 46 and/or the measured value provided by the hydraulic pressure sensor 86 and/or another sensor value for the respective crop throughput.

As described above, the device 98 needs a prediction model 132 which, amongst other things, considers a time-dependent forecast of the stand density of the crop picked up, depending on the time. A camera 94 (used as a device for determining the expected stand density of the crop picked up by the harvesting machine 10), which may be a mono or stereo camera in the visible or another frequency range, determines an expected stand density 162 as a function of the location by image processing arranged downstream, by using the images recorded thereby of the crop standing in front of the harvesting header 18. A laser or radar sensor can also be used instead of or in addition to a camera 94. Alternatively or additionally, a position determining device 92 used as a device (in conjunction with a map for the stand densities that is stored in a memory of the control device 80) for determining the expected stand density of crop picked up by the harvesting machine 10 can establish the current position and direction of travel of the harvesting machine 10 and, by using data stored in the map, which have been obtained during previous harvesting operations or during the growth period of the crop or during adjacent runs over the field during the present harvesting operation by the harvesting machine 10 or another harvesting machine, can provide an expected crop stand density 162 as a function of the location. A further possible variant provides for the assumption of a constant stand density which is constant over the prediction horizon but the value of which is adapted continuously during the harvesting by using the stand densities measured in the harvesting machine 10. As a result, the control algorithm can estimate better how highly the speed should be varied.

This expected, location-dependent stand density 162 is fed to a fusion unit 120, which also receives the signals from the sensors 140 discussed above (or at least a part thereof) and outputs a signal 158 which represents an expected stand density as a function of the location. The fusion unit 120 can convert the stand density 162 as is supplied by the camera 94 and/or the map into absolute values, by using the signals from the sensor 140. The fusion unit 120 compares the current throughput with the throughput which is determined by the prediction of the stand density and the speed of travel. From this, by using the measured values from the sensors 140, a scaling parameter is calculated in order to convert the sensor predictions of the stand density 162, which, for example, are measured in the unit growth height (cm) or mass or volume of the plants per unit area, into predictions of the stand density 158 based on the sensor values, for example into electrical voltage or t/h.

By using the sequence 154, the conversion device 106 converts the location-based stand densities 158 into time-dependent signals 160 (pₙₒₘᵢₙₐₗ) which are in turn fed to the forecasting model 108, as described in European Patent No. EP 3 348 130 A1.

The signals from the sensors 140 or some thereof are additionally fed to a state observer 144 and a model adaptation function 146. The state observer 144 is used to derive data 170 relating to the respective operating state of the harvesting machine 10 from the signals from the sensors 140, which data are fed to the forecasting model 108, including the current stand density which is detected by one or more of the sensors 140. If necessary, the model adaptation function 146 creates data 152 for adapting the forecasting model 108 and likewise feeds them to the latter.

The processes described are repeated in successive following steps. The parameters of the forecasting model 108 are also updated during each or some repetition steps, based on the detected measured variables which are fed to the state observer 144 and the model adaptation function 146.

The procedure of the control device 80 described to this point like European Patent No. EP 3 348 130 A1, the disclosure of which is incorporated in the present documents by reference. The sequence 154 of the control commands is calculated in such a way that the throughput of the harvesting machine 10 is always as far as possible equal to a target value, which lies close to a maximum throughput or corresponds thereto. In specific cases, for example when the device for determining the expected stand density of the crop picked up by the harvesting machine 10 fails because of poor viewing conditions of the camera 94 or unrelated maps or models for deriving the stand density from the map, this procedure can lead to a lower or thinner stand being expected than actually runs in. The harvesting machine 10 accordingly moves more quickly than would correspond to the actual stand density. This in turn results in overloading of the internal combustion engine 42, the lowering of its rotational speed and the resultant poor processing of the crop in the harvesting machine 10 and, in the extreme case, even blockage of the harvesting header 18 of the feeder house assembly 20 or the axial threshing unit 22 is possible. In other words, undesired operating situations are possible if the actual stand density of the crop is higher than the expected stand density. However, it is also conceivable that the forecast stand density is greater than that which is actually harvested. This would lead to lower utilization of the harvesting machine 10, which is likewise undesired.

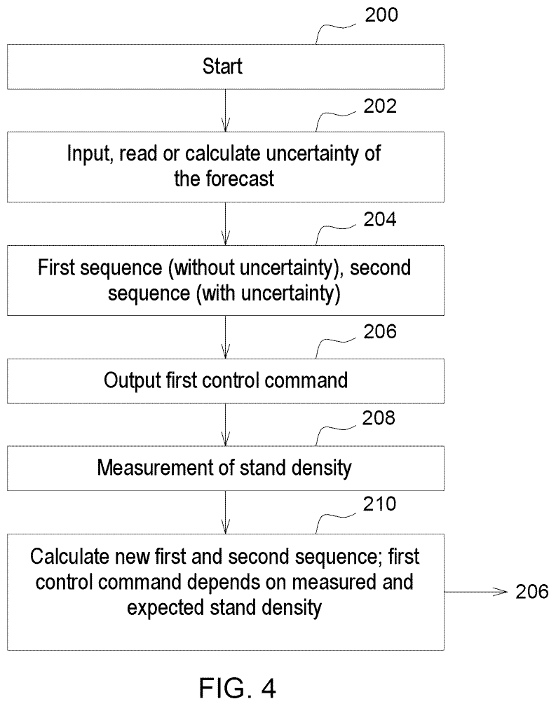

To avoid this problem (see also the flow chart of FIG. 4), one or more parameters 164 relating to an uncertainty of the stand density to be expected is or are fed to the device 98 (step 202). The device 98 determines (step 204) not only the sequence 154 uₙₒₘᵢₙₐₗ of the control commands calculated by using the expected stand density, but a second sequence 166 u_{robust} of the control commands, which is calculated as a function of the parameter 164 by taking the expected stand density into account, in such a way that the sequence 166 takes account of this uncertainty. The second sequence 166 is accordingly calculated more cautiously and includes lower speed values, which are calculated in such a way that the undesired overloading does not occur, even if the actual value of the stand density were to be greater by the uncertainty than the forecast stand density. The chronologically first value of the two sequences 154, 166 is identical and is also fed to the speed presetting device 102 (step 206). Both sequences 154, 166 are fed to the conversion device 106, which also converts the second sequence 166 into time-dependent stand density values 168 ρ_{robust} and in turn feeds these to the forecasting model 108. The stand density which results after a certain time is determined (step 208).

The parameter 164 is also fed to the state observer 144 and the model adaptation function 146. These can adapt their starting values 152, 170 on this basis, i.e. provide two sets of starting values, which are calculated with and without the uncertainty of the stand density.

In the next step (step 210) of the calculation of the sequences 154, 166, two new sequences 154, 166 are calculated based on new state measurements of the harvesting machine 10, including the measured loading of the internal combustion engine 42 and/or of the throughput detected by using the hydraulic pressure sensor 82 (step 208). Accordingly, two new sequences 154, 166 are calculated, of which the first is calculated without and the second is calculated with account being taken of the uncertainty. The measurement of the actual stand density enters the calculation in the form that the state observer 144 forwards to the forecasting model 108 a state in which the actual stand density is represented and/or in that the model adaptation function 146 is appropriately updated. Both sequences 154, 166 contain a corresponding chronologically first value, as also in step 204. This chronologically first value calculated by the device 98 and the solution device 100 incorporates, inter alia, the better, i.e. more relevant, sequence of the two sequences calculated in the preceding step, not directly but indirectly via the solution of the optimization problem while taking the cost function into account. Step 206 follows once more. However, the chronologically first value of the two sequences 154, 166 also considers the uncertainty of the forecast of the stand density (parameter 164).

The underlying idea of the present procedure is based on the theory of robust model-predictive control. The main problem for model-predictive control is the “recursive feasibility”: The question is, if the optimization problem can be solved at the time t without system restrictions being infringed, whether a solution at the time t+1 also exists. The optimization problem is solved over a finite prediction horizon, but “recursive feasibility” is desired over an infinite time period.

For the case without model uncertainties, the recursive feasibility can be demonstrated as follows: The solution sequence U=[u(0),u(1), . . . , u(N−1)] is considered at the time t(0), with the condition that the predicted system state at the end of the prediction horizon N is present in an invariant set. The invariant set states that, for every system state, it is possible to guarantee that a solution exists which satisfies the system restrictions, and that the next system state also lies in the invariant set.

At the next time t(1), the preceding solution sequence can be used again by being shifted U(1)=[u(1),u(2), . . . , u_(N−1), u(N)]. A new element u(N) exists, since the system state lies in the invariant set. However, it is also possible that the algorithm will find a better solution sequence which satisfies the system restrictions. This method can be repeated “recursively”, and thus the feasibility of the problem is given for every time.

For the case with model uncertainties, the optimization problem can now be extended with the model errors. The solution sequence U=[u(0),u(1), . . . , u_(N−1)], which takes the usual predictions into account, is considered at the time t(0). Furthermore, the sequence Urobust=[u(0)robust,u(1)robust, . . . , u(N−1)robust], which solves the optimization problem for the case with model errors, is considered. It is true that u(0)=u(0) robust and the last elements of the two solution sequences lie in an invariant set which is invariant for both systems.

At the next time t(1), the system state, which is equal to one of the extreme possible system states or lies between these, is measured. This means that there exists a new solution sequence which is a combination of the two previous ones. One possible solution is always to take the “worst-case” sequence. However, it should be noted that this would be sub-optimal. For this reason, the solution algorithm will calculate a new sequence which minimizes the cost function and takes the system restrictions into account.

An every-day example as an illustration. An automobile driver is traveling in dense fog. A ban on poor-visibility driving applies and the automobile should thus come to a standstill at the end of the range of visibility. The range of visibility corresponds to the prediction horizon, and the speed v=0 km/h is an invariant state for the automobile: If the automobile is at a standstill and not accelerated, it will also be at the same place at the next time.

The automobile driver has two models in their head: In the best case, nothing happens, and they can drive on at a constant speed. In the worst case, a stationary obstacle appears in the fog, and they must carry out full braking. One solution sequence comprises constant speeds and the “worst-case” sequence comprises full braking.

At the time t(1), a slowly moving automobile then appears in the fog. This corresponds neither to the best case in which no obstacle appears nor the worst case in which a stationary obstacle appears. Consequently, the driver carries out a combination of the two previous solution sequences and brakes gently. Full braking would also be a possible solution, but this will be sub-optimal, since the driver wishes to travel as fast as possible (according to the cost function).

While the algorithm can be defined in such a way that the cost function is applied only to the first sequence 154 without model errors (parameter 164) (and the calculation of the second sequence can be restricted to the calculation of the chronologically first element of the second sequence 166, i.e. the calculation of the complete sequences 166 and 168 and their forwarding to the fusion unit 120 and the forecasting model 108 can be dispensed with; however, one advantage of taking account of the complete second sequence 166, 168, shown in FIG. 3, consists in the fact that the harvesting machine 10 can be at various locations with various stand densities in the future, so that the result over the time horizon is different stand density variations, which can be taken into account in step 210, for example by the predicted stand density being determined from the maximum of the two stand density sequences or this maximum being used to calculate the second speed sequence), the sense in calculating the second sequence or its chronologically first value lies in obtaining a guarantee that there exists a solution if a model error occurs. As in the example with the automobile in fog, a comparison is not explicitly made as to which solution sequence is the better. The solution sequence without model errors mostly minimizes the costs and will always be taken as long as both sequences satisfy all the system restrictions (=full braking is possible without striking the obstacle or the forecast stand density is correct). The newly measured state has new information (=slowly traveling automobile in fog or the forecast stand density is not correct), and the sequences are accordingly re-calculated. The “worst-case” sequence from the preceding time step guarantees “recursively” that a new solution exists. In other words, the first value of the new sequence is calculated such that a solution to the problem also exists for the future even if the model errors (parameter 164) were to occur. As a result, in the example of the automobile, driving into an obstacle and, in the case of the harvesting machine, an undesired operating state, such as overloading or blockage, are avoided. The uncertainty of the stand density is accommodated in the first sequence via the first value of the second sequence after the entire optimization algorithm has been processed while taking the uncertainty into account. As a result of the equality of the first elements of the sequences, the speed command is conservative enough to avoid overloading in the worst case.

It should also be noted that the measurement of the throughput after the crop has been picked up is carried out with a time delay, since the sensors are not located in the cutter unit 18 or in the feeder house 20 but on the threshing rotor 22 or the screw conveyor of the grain tank. As a result, it is possible that the combine harvester 10 is already overloaded at the inlet without this being measured by the sensors. From a certain point of view, this is a sensor error, but which is caused by the time delay in the measuring operation. This time delay can have a very detrimental effect on the control quality. In a way analogous to the “worst-case” stand density, it is now possible to define a “worst-case” machine state which takes account of this uncertainty. This “worst-case” machine state can be used to calculate the second speed sequence, while the first speed sequence is calculated based on the actual sensor values.

For the case in which the stand density is lower than assumed, it would also be conceivable to calculate more than two sequences which take different extreme cases into account, i.e. a third sequence or at least its chronologically first value, of which the uncertainty is opposite to the uncertainty of the second sequence. If, accordingly, too low a forecast stand density is assumed in the second sequence, the third sequence uses a forecast stand density that is too high. It must always be true that the first elements of the sequences are the same. Possible extreme cases would be maximum and minimum values of the stand density 158 of the adapted model parameters (i.e. starting values 152 of the model adaptation function 146), the system states (i.e. starting values 170 of the state observer 144) or combinations of the cases, for example underestimating the stand density and the adapted model parameters and system states. The uncertainties of the adapted starting values 152 and/or 170 can also be considered (or on their own, instead of the uncertainty of the stand density) if only one second sequence or at least the chronologically first value thereof is calculated. These uncertainties of the adapted starting values 152 and/or 170 are in turn once more based on the parameter 164 which is fed to the model adaptation function 146 and to the state observer 144.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

Although the present disclosure has been described in terms of specific examples and applications, persons skilled in the art can, considering this teaching, generate additional examples without exceeding the scope or departing from the spirit of the present disclosure described herein. Accordingly, it is to be understood that the drawings and description in this disclosure are proffered to facilitate comprehension of the present disclosure and should not be construed to limit the scope thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

It should also be noted that the different examples described herein can be combined in different ways. That is, parts of one or more examples can be combined with parts of one or more other examples. All of this is contemplated herein.

1. A system for the automatic control of a forward drive speed of a harvesting machine comprising:
a controller configured with a function device and a solution device, wherein the function device is configured, in chronologically successive steps, taking into account a location-dependent forecast for an expected crop stand density and a measured crop stand density in the harvesting machine to create a cost function and an associated optimization problem with the effect of optimizing a state of the harvesting machine and the solution device is configured to provide respective chronologically successive first sequences of control variables relating to a pre-definition of the forward drive speed, which solve the respective optimization problem and minimize the associated cost function; and
a valve control device configured to influence the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

2. The system of claim 1 wherein the parameter is established by at least one of fixedly predefining the parameter, entering the parameter by an operator via an operator interface and determining the parameter by one or more sensors.

3. The system of claim 2 wherein the determination of the parameter by sensors is carried out by using a comparison between at least one of the expected and measured crop stand density, using a determined machine state and using a detection of ambient conditions.

4. The system of claim 3 wherein it is possible to predefine via an operator interface a weighting as to whether a safer operation using a speed control based on the second sequence or a faster operation based on the first sequence, is preferred, preferably with the possibility of entering intermediate values.

5. The system of claim 4 wherein the controller is configured to incorporate the parameter relating to the uncertainty of the crop stand density into the first sequence via the first value of the second sequence after the optimization algorithm for creating the optimization problem and the cost function has been processed by the solution device while taking the uncertainty into account.

6. The system of claim 5 wherein the function device is configured to continuously create at least one chronologically first value of the control command of a third sequence which, while taking the expected crop stand density and a subsequent parameter opposite to the initial parameter for the uncertainty into account, is calculated in such a way that this uncertainty is taken into account, wherein the chronologically first value of all three sequences is identical.

7. The system of claim 6 wherein the function device is configured using, instead of or in addition to the initial parameter relating to the uncertainty of the expected crop stand density, a subsequent parameter relating to the uncertainty of an output value of at least one of a state observer and a model adaptation function.

8. The system of claim 7 wherein the output values are fed to a forecasting model, which creates a prediction model for the function device for creating the optimization problem and the cost function.

9. The system of claim 8 wherein the uncertainty of the output values of at least one of the state observer and the model adaptation function is based on the initial parameter which is fed to at least one of the state observer and the model adaptation function.

10. A harvesting machine comprising:
a controller configured with a function device and a solution device, wherein the function device is configured, in chronologically successive steps, taking into account a location-dependent forecast for an expected crop stand density and a measured crop stand density in the harvesting machine to create a cost function and an associated optimization problem with the effect of optimizing a state of the harvesting machine and the solution device is configured to provide respective chronologically successive first sequences of control variables relating to a pre-definition of the forward drive speed, which solve the respective optimization problem and minimize the associated cost function; and
a valve control device configured to influence the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

11. The harvesting machine of claim 10 wherein the parameter is established by at least one of fixedly predefining the parameter, entering the parameter by an operator via an operator interface and determining the parameter by one or more sensors.

12. The harvesting machine of claim 11 wherein the determination of the parameter by sensors is carried out by using a comparison between at least one of the expected and measured crop stand density, using a determined machine state and using a detection of ambient conditions.

13. The harvesting machine of claim 12 wherein it is possible to predefine via an operator interface a weighting as to whether a safer operation using a speed control based on the second sequence or a faster operation based on the first sequence, is preferred, preferably with the possibility of entering intermediate values.

14. The harvesting machine of claim 13 wherein the controller is configured to incorporate the parameter relating to the uncertainty of the crop stand density into the first sequence via the first value of the second sequence after the optimization algorithm for creating the optimization problem and the cost function has been processed by the solution device while taking the uncertainty into account.

15. The harvesting machine of claim 14 wherein the function device is configured to continuously create at least one chronologically first value of the control command of a third sequence which, while taking the expected crop stand density and a subsequent parameter opposite to the initial parameter for the uncertainty into account, is calculated in such a way that this uncertainty is taken into account, wherein the chronologically first value of all three sequences is identical.

16. The harvesting machine of claim 15 wherein the function device uses, instead of or in addition to the initial parameter relating to the uncertainty of the expected crop stand density, a subsequent parameter relating to the uncertainty of an output value of at least one of a state observer and a model adaptation function.

17. The harvesting machine of claim 16 wherein the output values are fed to a forecasting model, which creates a prediction model for the function device for creating the optimization problem and the cost function.

18. The harvesting machine of claim 17 wherein the uncertainty of the output values of at least one of the state observer and the model adaptation function is based on the initial parameter which is fed to at least one of the state observer and the model adaptation function.

19. A method for the automatic control of a forward drive speed of a harvesting machine comprising:
providing a controller configured with a function device and a solution device;
generating, with the function device, in chronologically successive steps, a location-dependent forecast for an expected crop stand density and a measured crop stand density in the harvesting machine to create a cost function and an associated optimization problem with the effect of optimizing a state of the harvesting machine;
generating, with the solution device, respective chronologically successive first sequences of control variables relating to a pre-definition of the forward drive speed, which solve the respective optimization problem and minimize the associated cost function; and
influencing, with a valve control device, the forward drive speed of the harvesting machine by generating respective chronologically first control commands of each first sequence, wherein a parameter relating to an uncertainty of the expected crop stand density can be fed to the function device, and wherein the function device is configured to continuously create at least one chronologically first value of the control commands of a second sequence, which, while taking account of the expected crop stand density and of the parameter, is calculated in such a way that this uncertainty is taken into account, wherein the chronologically first value of the first and second sequences is identical.

20. The method of claim 19 further comprising the step of establishing the parameter is by at least one of fixedly predefining the parameter, entering the parameter by an operator via an operator interface and determining the parameter by one or more sensors.
